(19) United States
(12) Patent Application Publication
(10) Pub. No.: US 2021/0056154 A1
(43) Pub. Date: Feb. 25, 2021

(54) USER INFORMATION SHARING APPARATUS, USER INFORMATION SHARING METHOD AND USER INFORMATION SHARING SYSTEM

(71) Applicant: HONDA MOTOR CO., LTD., Tokyo (JP)

(72) Inventors: Shiro KITAMURA, Wako-shi (JP); Jumpei MORITA, Wako-shi (JP); Yo ITO, Tokyo (JP); Shuji NAKAYAMA, Tokyo (JP)

(73) Assignee: Honda Motor Co., Ltd., Tokyo (JP)

(21) Appl. No.: 16/978,392

(22) PCT Filed: Mar. 12, 2019
(86) PCT No.: PCT/JP2019/009900

§ 371 Date: Sep. 4, 2020

(30) Foreign Application Priority Data
Mar. 13, 2018 (JP) 2018-045264

(51) Int. Cl. G06F 16/9536; G06F 16/9535

(52) U.S. Cl. CPC G06F 16/9536; G06F 16/9535

(57) ABSTRACT

A user information sharing apparatus includes: a CPU and a memory coupled to the CPU. The memory is configured to store time-series user information of a plurality of users including information about events from past to present occurred to each of the plurality of users. The CPU is configured to perform: receiving a reference request from a first user for the user information of other users stored in the memory; extracting the user information of a second user similar to the first user from among the user information stored in the memory, when the reference request from the first user is received; and outputting the user information of the second user extracted.

### CROSS-REFERENCE TO RELATED APPLICATION

This application is a National Stage of PCT international application Ser. No. PCT/JP2019/009900 filed on Mar. 12, 2019 which designates the United States, incorporated herein by reference, and which is based upon and claims the benefit of priority from Japanese Patent Application No. 2018-045264, filed on Mar. 13, 2018, the entire contents of which are incorporated herein by reference.

### TECHNICAL FIELD

This invention relates to a user information sharing apparatus, a user information sharing method and a user information sharing system for sharing user information.

### BACKGROUND ART

Conventionally, as a technique of this type, there has been known a device in which information such as blog articles inputted via a user terminal is disclosed on networks and information is shared with other users (for example, Patent Document 1). In the apparatus of Patent Document 1, it is determined whether or not an event affecting the emotion has occurred based on the number of key-presses of the portable terminal, and only information relating to the event affecting the emotion is extracted from the input past information.

### CITATION LIST

### Patent Literature

Patent Document 1: Japanese Unexamined Patent Publication No. 2014-191731

### DISCLOSURE OF INVENTION

### Problems to be Solved by the Invention

In the apparatus described in Patent Document 1, since information is selected according to the degree of influence on the emotion of the user who has input information, it is difficult to efficiently extract information useful to other users.

### Means for Solving Problem

An aspect of the present invention is a user information sharing apparatus, including: a storage unit configured to store time-series user information of a plurality of users including information about a plurality of life events from past to present occurred to each of the plurality of users; a reception unit configured to receive a reference request from a first user for the user information of other users stored in the storage unit; an information extract unit configured to extract the user information of a second user similar to the first user from among the user information stored in the storage unit, when the reference request from the first user is received by the reception unit, a degree of similarity regarding the plurality of life events between the user information of the first user and the user information of the second user being high; and an output unit configured to output the user information of the second user extracted by the information extract unit.

Another aspect of the present invention is a user information sharing method, including: storing time-series user information of a plurality of users including information about a plurality of life events from past to present occurred to each of the plurality of users; receiving a reference request from a first user for the user information of other users stored; extracting the user information of a second user similar to the first user from among the user information stored, when the reference request from the first user is received, a degree of similarity regarding the plurality of life events between the user information of the first user and the user information of the second user being high; and outputting the user information of the second user extracted.

Another aspect of the present invention is a user information sharing system, including: the user information sharing apparatus; a plurality of information collection device configured to collect the user information of the plurality of users and transmit to the user information sharing apparatus; and a user terminal configured to transmit the reference request from the first user to the user information sharing apparatus, receive the user information of the second user output from the user information sharing apparatus, and present the first user, in response to manipulation by the first user.

### Effect of the Invention

According to the present invention, information useful to the user can be efficiently extracted and shared.

### BRIEF DESCRIPTION OF DRAWINGS

FIG. 1 is a drawing schematically showing overall configuration of a user information sharing system according to an embodiment of the present invention;

FIG. 2 is a block diagram schematically showing configuration of a user information sharing apparatus according to the embodiment of the present invention;

FIG. 3 is a drawing for explaining a life log stored in a storage unit of the user information sharing apparatus of FIG. 2;

FIG. 4 is a drawing for explaining quantifying of a degree of similarity between the life logs;

FIG. 5A is a drawing showing an example the life log extracted by an information extract unit of the user information sharing apparatus of FIG. 2;

FIG. 5B is a drawing showing another example the life log extracted by the information extract unit of the user information sharing apparatus of FIG. 2; and

FIG. 6 is a flowchart showing an example of processing performed by the user information sharing apparatus according to the embodiment of the present invention.

### DESCRIPTION OF EMBODIMENT

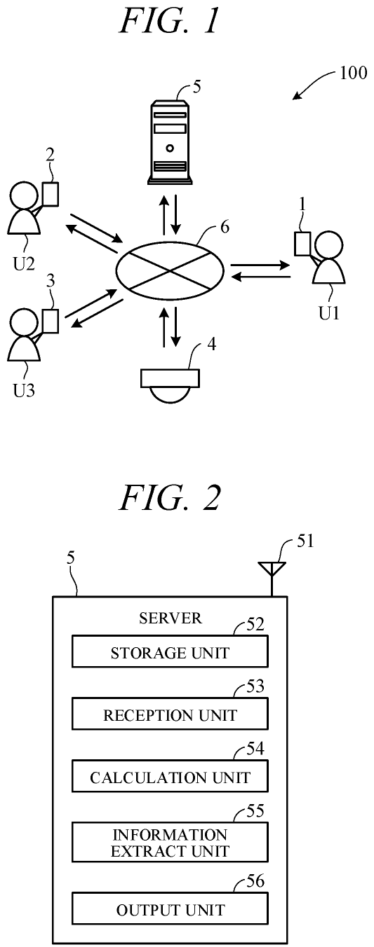

An embodiment of the present invention is explained with reference to FIGS. 1 to 6 in the following. A user information sharing system according to the embodiment of the present invention collects and accumulates user information (life log) such as events that have occurred to respective users from a large number of users, and extracts and shares (presents) useful information to users who wish to refer to the accumulated information. By referring to the life log of others, the user can make use of it in various choices in the branch of his/her life and in his/her daily life.

FIG. 1 is a diagram schematically illustrating an overall configuration of a user information sharing system 100 according to the embodiment of the present invention. The user information sharing system 100 includes a plurality of user terminals 1, 2 and 3 respectively owned by a plurality of users U1, U2 and U3, a public information collection device 4 installed in a public space, and a server 5 which is the user information sharing apparatus. These user terminals 1 to 3, public information collection device 4 and server 5 are connected to a network 6 including a public wireless communication network such as an Internet network or a mobile telephone network, and can communicate with each other via the network 6. The network 6 also includes closed communication networks, such as wireless LANs, Wi-Fi (Registered Trademark) and Bluetooth (Registered Trademark), which are established for each designated control area.

The user terminals 1 to 3 is composed of, for example, smart phones, wearable terminals, personal computers, or the like. The user terminals 1 to 3 include, for example, various sensors such as an input unit such as a touch panel operable by a user or a microphone capable of inputting an audio instruction, a camera for acquiring an image or sound, a position sensor for acquiring position information, and a vital sensor for acquiring biological information. The user terminals 1-3 transmits user information such as information about birth date, occupation, scheduling, posting to the social network service (SNS) or the like inputted by the user, video and audio information, position information, biometric information or the like of the user acquired by various sensors, to the server 5 via the network 6. User information transmitted from each of the user terminals 1 to 3 are assigned with identification information for each of the users U1 to U3 (e.g., user ID). Further, each of the user terminals 1-3 transmits a reference request (described later) of the other party's user information input by each of the users U1 to U3 via the input unit.

The public information collection device 4 is a device for collecting public information such as video and audio information of the public space, and is composed of, for example, surveillance cameras installed in the public space such as roads and public facilities. The public information collection device 4 acquires user information such as video and audio information of the user in the public space, and transmits the acquired user information, along with time information and position information of the public information collection device 4, to the server 5 through the network 6.

That is, user information acquired by the user terminals 1 to 3 and the public information collection device 4 is transmitted to the server 5 as digital data including events occurred for the users U1 to U3. Events mean actions (or behaviors) itself selected by each user from time to time, and includes everything such as commuting, schooling, learning, and traveling.

FIG. 2 is a block diagram showing a schematic configuration of the server 5. The server 5 includes a processor, memory, and the like, i.e., an arithmetic processing unit having CPU, ROM, RAM and other peripheral circuitry, and can communicate with the user terminals 1 to 3 and the public information collection device 4 through a communication unit 51. As shown in FIG. 2, the server 5 includes, as a functional configuration, a storage unit 52 configured to store user information, a reception unit 53 configured to receive the reference request for user information, a calculation unit 54 configured to calculate a degree of similarity of user information by quantifying, an information extract unit 55 configured to extract user information based on the degree of similarity, and an output unit 56 configured to output the extracted user information. The functions of the storage unit 52 are handled by the memory, and the functions of the reception unit 53, calculation unit 54, information extract unit 55 and output unit 56 functions are handled by the processor.

The storage unit 52 stores user information from the user terminals 1 to 3 and the public information collection device 4 acquired through the communication unit 51 in time series for each of the users U1 to U3 as the life log of each of the users U1 to U3. When the information acquired from each of the user terminals 1 to 3 includes the face information of each users U1 to U3, the face information included in the image acquired from the public information collection device 4 is compared with the face information of each users U1 to U3 and stored as the life log of each of the users U1 to U3 according to the comparison result.

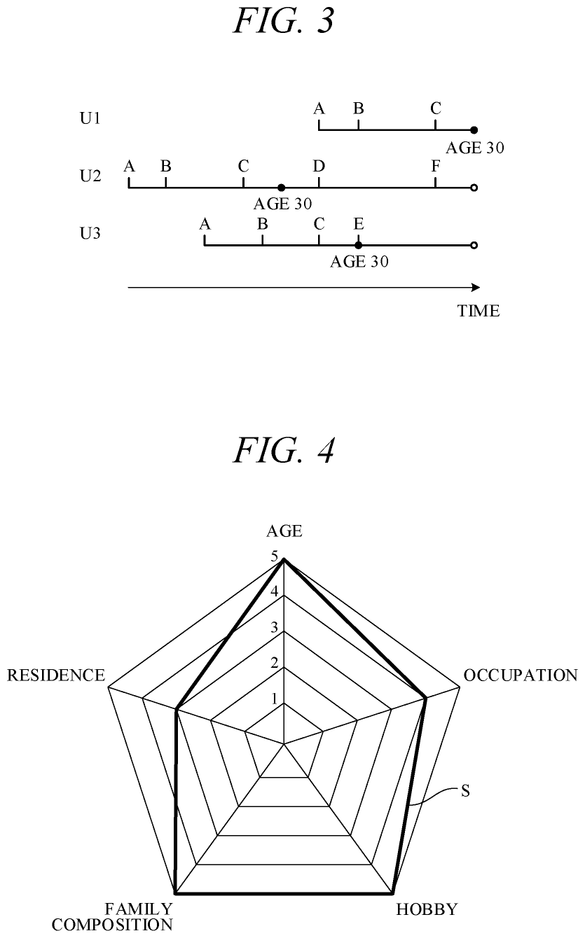

FIG. 3 is a diagram for explaining the life log stored in the storage unit 52. The life log stored in time series for each of the users U1 to U3 is organized and managed by life events A to F. Specifically, the life log of each users U1 to U3 is arranged in time series and depending on whether it is before or after each life event. A life event is a milestone in life for all users, including, for example, his or her birth (A), school (B), employment (C), marriage (D), job change (E), retirement (F), etc.

By sharing such life logs, the user can use the selection of the previous actions of others (predecessors) as a reference for the selection of various future actions in the branch of his/her own life and in his/her daily life. However, the life log of others (past selection of actions) may include a lot of information that is not useful for himself/herself as well as information that is useful for himself/herself. For example, the life log of others who are younger than himself/herself, or the life log of others whose environments, such as occupation and place of residence, differ greatly is highly unlikely to be helpful to the user.

Many people are thought to explore their own ways of life and identities at similar times, such as around the age of twenty when they become working adults, around the age of thirty when a life turning point such as marriage is coming, or around the age of sixty when they reach retirement age, and choose their actions according to their respective environments. Therefore, useful information can be obtained by extracting the life log of others in an environment similar to that of the user after a predetermined time point at which the user selects their own actions.

The reception unit 53 in FIG. 2 receives the reference request for the other party's life log transmitted from each of the user terminals 1 to 3, for example, from the user terminal 1 of the youngest user U1 among the users U1 to U3.

When the reference request is received by the reception unit 53, the calculation unit 54 calculates the degree of similarity between the life log up to the present age of the user U1 who transmitted the reference request and the life logs up to the same age of the other users U2, U3, by quantifying.

FIG. 4 is a diagram for explaining the quantifying of the degree of similarity of the life logs. The degree of similarity of the life logs up to a certain time point can be assessed by various parameters including, for example, the age, occupation, hobbies, family composition, residence, etc. of the respective user at that time point. Specifically, the degree of similarity is quantified for each parameters. For example, if the parameter is the age, the degree of similarity is quantified as 5 points for the same age and quantified as 4 points for one year apart; if the parameter is occupation, the degree of similarity is quantified as 5 points for the same occupation and quantified as 4 points for the same industry. The degree of similarity of the life log as a whole is calculated, for example, as an area S of the radar chart of FIG. 4.

The information extract unit 55 of FIG. 2 extracts the life log of the user U2, U3 from the predetermined time point to present, whose degree of similarity of the life log calculated by the calculation unit 54 is higher (for example, the calculated area S is equal to or greater than a predetermined value).

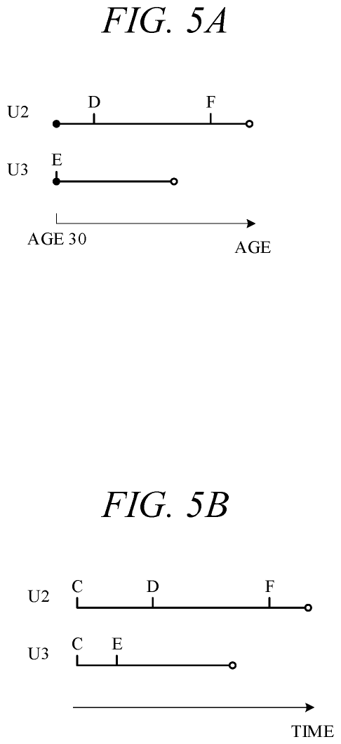

FIG. 5A and FIG. 5B are diagrams showing an example of the life log extracted by the information extract unit 55. In the example of FIG. 5A, upon reception of the reference request from the user U1 at the age of thirty, the life logs of users U2, U3 after the age of thirty are extracted from among the life logs shown in FIG. 3. On the other hand, in the example of FIG. 5B, upon reception of the reference request for the life log after employment (C) from the user U1, the life logs of users U2, U3 after employment (C) are extracted from among the life logs shown in FIG. 3.

The output unit 56 of FIG. 2 transmits the life log extracted by the information extract unit 55 to the user terminal 1 of the user U1. It is preferable to exclude personal information such as specific occupations and residences of the users U2, U3 from the information transmitted to the user U1. The information to be transmitted to the user U1 should at least contain an event information about when and what actions the users U2, U3 had selected, which is useful for the user U1 in choosing future actions. The event information may include, for example, the content of posting to the SNS in accordance with the setting of the disclosure range by each user.

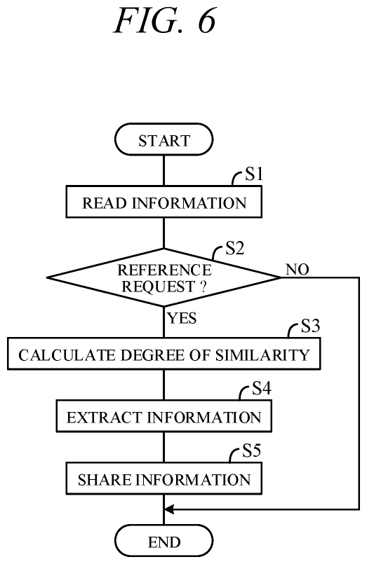

FIG. 6 is a flowchart illustrating an example of a process executed by the server 5 in accordance with a program stored in the memory in advance. The process shown in the flow chart is started, for example, when the power of the server 5 is turned on, and is repeated at a predetermined cycle. First, in step S1, user information received from the user terminals 1 to 3 and the public information collection device 4 via the communication unit 51 is read and stored in the storage unit 52. Next, in step S2, it is determined whether or not the reference request from the user U1 is received by the reception unit 53, and if the result is affirmative, the process proceeds to step S3, and if the result is negative, the process ends. In step S3, the degree of similarity between the life log of the user U1 before the predetermined time point and the life logs of the users U2, U3 is calculated as the area S of the radar chart (shown in FIG. 4) by the calculation unit 54. Next, in S4, the life logs of the users U2, U3, for whom the area S calculated by the calculation unit 54 is equal to or greater than the predetermined value, from the predetermined time point to present is extracted by the information extract unit 55. Next, in S5, a part of the life logs extracted by the information extract unit 55 is transmitted to the user terminal 1 by the process in output unit 56.

The main operation of the user information sharing system 100 according to the present embodiment will be described in detail by referring to FIG. 5A and FIG. 5B. The user U1 is a 30-year-old woman who is looking for a future life. When the user U1 sends the reference request of the other party's life logs via the user terminal 1, the life logs after the age of thirty to present of the female users U2, U3 who was in the same industry as the user U1 at the age of 30 is transmitted to the user terminal 1 (S2 to S5, FIG. 5A).

According to the shared life logs (FIG. 5A), the user U2 got married (D) several years after the age of thirty, and worked in the same industry as the user U1 until she retired (F). The user U3 started business (E) independently at the age of thirty. By referring to the life log of the user U2 who selected the action of balancing work and family even after marriage in a similar environment, the user U1 can gain confidence that she can select such actions. In addition, by referring to the life log of the user U3 who selected the action of starting a business in a similar environment, the user U1 can become aware of her own possibility that she did not recognize by herself. That is, the user U1 may bring “blind spot windows” in the Johali window, which are not noticed by the user U1 herself but are noticed by the other user U3 or the user information sharing system 100, close to “open windows” in the Johali window, which are disclosed to both of the public and the user U1 herself. By being aware of her own potential, the user U1 can broaden the range of actions that she may choose.

The user U1 may also require references to the life logs after a particular life event. When the user U1 transmits the reference request by specifying life event of employment (C) via the user terminal 1, the life logs of the users U2, U3 from the time of the employment (C) to present is transmitted to the user terminal 1 (S2 to S5, FIG. 5B). By referring to such life logs (FIG. 5B), the user U1 can know how many years after the employment (C) the users U2, U3 selected their actions D, E, and F, respectively, and can use the information as information for considering the selection timing of her future actions.

The user U1 may also require references to the life logs that are narrowed down to events that meet seasonal or weather conditions. In this instance, the information presented to the user U1 is narrowed down to information of the same season or the same weather. Therefore, the user U1 can refer to what kind of actions other people in similar environments selected in the same season or the same weather condition. For example, when it is used as a reference for job change activities, it can be narrowed down by seasonal conditions such as when there are many people changing jobs; when it is used as a reference for the selection of venues for weddings, it can be narrowed down by seasonal conditions; and when it is used as a reference for kind of training athletes in the same sport were doing before the tournament, it can be narrowed down by weather conditions. Therefore, it is possible to obtain information more suited to the situation of the user U1 himself/herself.

That is, according to the present embodiment, it is possible to efficiently extract information useful for the user U1 from among the life logs of others and share the extracted information.

The present embodiment can achieve advantages and effects such as the following:

(1) As the user information sharing apparatus, the server 5 includes: the storage unit 52 configured to store the life logs as time-series user information of the users U1 to U3 including information about events from past to present occurred to each of the users U1 to U3; a reception unit 53 configured to receive the reference request from the user U1 for the life logs of other users U2, U3 stored in the storage unit 52; the information extract unit 55 configured to extract the life logs of the users U2, U3 similar to the user U1 from among the life logs stored in the storage unit 52, when the reference request from the user U1 is received by the reception unit 53; and the output unit 56 configured to output the life logs of the users U2, U3 extracted by the information extract unit 55 (FIG. 2). Since the life logs of the other users U2, U3 in the similar environments as the user U1 is extracted based on the life logs of the users U1 to U3, it is possible to present future options useful for the user U1. For example, it is possible to present the life log of the user U2 who has selected the action of balancing work and family even after marriage in the similar environments as the user U1, or the life log of the user U3 who has selected the action of starting a business.

(2) The life log further includes information about at least one of an age, an occupation, a hobby, a family composition, and a residence of each of the users U1 to U3 (FIG. 4). With this, since the degree of similarity between the life logs of the users U1 to U3 can be assessed for each particular parameter, the degree of similarity between the life logs can be assessed appropriately.

(3) The life log includes information about an age of each of the users U1 to U3 at a time point of occurrence of each of the events. The information extract unit 55 is configured to extract the life log after a predetermined age from among the life logs of the users U2, U3 stored in the storage unit 52 (FIG. 5A). In particular, since the searching time for life events such as employment, marriage, job change, etc. is often the same age, by extracting the life logs after the predetermined age, it is possible to present the future choices which is more useful for the user U1.

(4) The information extract unit 55 is configured to extract the life log after a time point of occurrence of a predetermined event from among the life logs of the users U2, U3 stored in the storage unit 52 (FIG. 5B). By extracting the life logs after a predetermined life event, it is possible to present a more useful future choices for the user U1.

(5) The life log further includes information about a season at the time point of occurrence of each of the events. By narrowing down to seasonal conditions, it is possible to provide options suited to the user U1 situation.

(6) The life log further includes information about a weather at the time point of occurrence of each of the events. By narrowing down to weather conditions, it is possible to provide options more suited to the user U1 situation.

(7) The server 5 further includes: the calculation unit 54 configured to calculate by quantifying as an area S the degree of similarity between the life log of the user U1 and the life logs of the users U2, U3 before the predetermined age or before the time point of occurrence of the predetermined event, when the reference request from the user U1 is received by the reception unit 53. The information extract unit 55 is configured to extract the life logs of the users U2, U3, for whom the area S calculated by the calculation unit 54 is equal to or greater than a predetermined value (FIG. 4). By quantifying the degree of similarity between the life logs, the degree of similarity between the life logs can be evaluated more appropriately.

The above embodiment can be modified to various forms. Hereinafter, modified examples will be described. In the above embodiment, the single server 5 is exemplified as the user information sharing apparatus, but a user information sharing apparatus may be a cloud server composed of a plurality of servers.

In the above embodiment, the user information sharing system 100 including the user terminals 1 to 3, the public information collection device 4 and the server 5 is exemplified, but configuration of a user information sharing system is not limited to such a configuration. For example, it may include only user terminals 1 to 3 or include only public information collection device 4. User terminals that make up a user information sharing system can be limited to the user terminals of users in a particular grouping.

In the above embodiment, the public information collection device 4 is exemplified as the surveillance cameras, but a public information collection device configuring a user information sharing system is not limited to this. The public information collection device may be any device that collects public information such as the public space video and audio information.

In the above embodiment, the life logs which is time series user information of the respective users stored in the storage unit 52 is organized by the life events A to F, but user information stored in a storage unit is not limited to this. For example, organized user information may be stored, for example, by classifying by age of each user.

In the above embodiment, the reception unit 53 receives the reference request to be transmitted when the user U1 desires to refer to the life log of another person, but a reference request to be accepted by a reception unit is not limited to this. For example, a reference request for the life logs on a monthly basis can be received.

In the above embodiment, the degree of similarity between the life logs is calculated as the area S of the radar chart by the calculation unit 54, but a degree of similarity between the life logs calculated by quantifying is not limited to this. For example, a plurality of radar charts may be created by classifying the radar charts into parameters relating to the user's inborn environment such as age and family composition, parameters relating to an environment as a result of the user's selection such as occupation, hobbies, and the like, and an average value of the areas may be calculated. The quantifying method is not limited to the method of calculating the area of the radar chart. The numerical values of the parameters may be weighted according to the user's settings or according to the results of analyzing the life log at the system. When the user decides the parameters to be emphasized in extracting the life log, the user can extract life logs of the directionality desired by the user. On the other hand, when the system determines the parameters to be emphasized, directional life logs that the user does not notice by himself or herself can be extracted.

In the above embodiment, the life logs after a predetermined time point are extracted by the information extract unit 55, but an information extract unit may extract the entire life logs of the users U2, U3 similar to the user U1.

The above description is only an example, and the present invention is not limited to the above embodiment and modifications, unless impairing features of the present invention. The above embodiment can be combined as desired with one or more of the above modifications. The modifications can also be combined with one another.

### REFERENCE SIGNS LIST

1 to 3 user terminal; 4 public information collection device; 5 server; 6 network; 51 communication unit; 52 storage unit; 53 reception unit; 54 calculation unit; 55 information extract unit; 56 output unit; 100 user information sharing system

1-9. (canceled)

10. A user information sharing apparatus, comprising:
a CPU and a memory coupled to the CPU, wherein
the memory is configured to store time-series user information of a plurality of users including information about a plurality of life events from past to present occurred to each of the plurality of users, wherein
the CPU is configured to perform:
receiving a reference request from a first user for the user information of other users stored in the memory;
extracting the user information of a second user from among the user information stored in the memory, when the reference request from the first user is received, a degree of similarity regarding the plurality of life events between the user information of the first user and the user information of the second user being high; and
outputting the user information of the second user extracted.

11. The user information sharing apparatus according to claim 10, wherein
the user information further includes information about at least one of an age, an occupation, a hobby, a family composition, and a residence of each of the plurality of users.

12. The user information sharing apparatus according to claim 10, wherein
the user information includes information about an age of each of the plurality of users at a time point of occurrence of each of the plurality of life events, wherein
the CPU is configured to extract the user information after a predetermined age from among the user information of the second user stored in the memory.

13. The user information sharing apparatus according to claim 10, wherein
the CPU is configured to extract the user information after a time point of occurrence of a predetermined life event from among the user information of the second user stored in the memory.

14. The user information sharing apparatus according to claim 10, wherein
the user information further includes information about a season at the time point of occurrence of each of the plurality of life events.

15. The user information sharing apparatus according to claim 10, wherein
the user information further includes information about a weather at the time point of occurrence of each of the plurality of life events.

16. The user information sharing apparatus according to claim 10, wherein
the CPU is configured to calculate by quantifying the degree of similarity regarding the plurality of life events between the user information of the first user and the user information of the second user before a predetermined age or before the time point of occurrence of a predetermined life event, when the reference request from the first user is received, wherein
the CPU is configured to extract the user information of the second user for whom the degree of similarity calculated is equal to or greater than a predetermined value.

17. The user information sharing apparatus according to claim 10, wherein
the CPU is configured to calculate the degree of similarity regarding the plurality of life events by quantifying as an area of a radar chart.

18. A user information sharing method, comprising:
storing time-series user information of a plurality of users including information about a plurality of life events from past to present occurred to each of the plurality of users;
receiving a reference request from a first user for the user information of other users stored;
extracting the user information of a second user similar to the first user from among the user information stored, when the reference request from the first user is received, a degree of similarity regarding the plurality of life events between the user information of the first user and the user information of the second user being high; and
outputting the user information of the second user extracted.

19. A user information sharing system, comprising:
the user information sharing apparatus according to claim 10;
a plurality of information collection devices configured to collect the user information of the plurality of users and transmit to the user information sharing apparatus; and
a user terminal configured to transmit the reference request from the first user to the user information sharing apparatus, receive the user information of the second user output from the user information sharing apparatus, and present the first user, in response to manipulation by the first user.
